(19) United States
(12) Patent Application Publication
(10) Pub. No.: US 2008/0123677 A1
(43) Pub. Date: May 29, 2008

(54) SYSTEM MANAGEMENT BUS PORT SWITCH

(75) Inventors: Stephen Cooley, Seminole, FL (US); Clifford E. Kimmery, Clearwater, FL (US); Louis F. Villarosa, Tampa, FL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc., Morristown, NJ (US)

(21) Appl. No.: 11/469,176

(22) Filed: Aug. 31, 2006

(51) Int. Cl. H04L 12/56; H04J 3/16

(52) U.S. Cl. 370/419; 370/466

(57) ABSTRACT

A method of sending data packets between a control processor and a plurality of peripheral components comprising retrieving information embedded in a command data packet formatted in a first protocol at a switch adapted to function as an alternate bus, forming a reformatted data packet at the switch, and transferring the reformatted data packet from the switch. The reformatted data packet is formatted according to a second protocol, and includes the retrieved information.

This application is related to U.S. patent applications Ser. No. ______ (Attorney Docket No. H0012926-5801) having a title of “A METHOD TO EMBED PROTOCOL FOR SYSTEM MANAGEMENT BUS IMPLEMENTATION” (also referred to here as the “H0012926-5801 Application”) filed on the same date herewith. The H0012926-5801 application is hereby incorporated herein by reference.

### GOVERNMENT LICENSE RIGHTS

The U.S. Government may have rights in the invention under a restricted government contract.

### BACKGROUND

An embedded computer system usually has several busing schemes which are used to transfer data packets and commands between components in the system. Sometimes these systems rely heavily on one primary bus. When an error or lockup occurs on the primary bus, the communication with the components connected to the primary bus is disrupted. In some cases, when an error or lockup occurs on the primary bus, the components connected to the primary bus are disabled.

A system with a redundant bus is complex and often requires a dedicated controller to determine which bus to use at any given time. In this case, the system includes additional hardware which adds to the development and hardware costs of the system. If the computer system is used in an airborne system, the redundant bus adds weight to the payload.

It is desirable to provide a backup serial bus without additional hardware.

### SUMMARY

A first aspect of the present invention provides a method of sending data packets between a control processor and a plurality of peripheral components comprising retrieving information embedded in a command data packet formatted in a first protocol at a switch adapted to function as an alternate bus, forming a reformatted data packet at the switch, and transferring the reformatted data packet from the switch. The reformatted data packet is formatted according to a second protocol, and includes the retrieved information.

A second aspect of the present invention provides a switch, a bus interface, a bus state machine and ports communicatively coupled to peripheral components. The switch includes a controller interface to receive data packets formatted according to a first protocol from a control processor. The bus interface reformats the received data packets from the first protocol to a second protocol. The bus state machine controls the functionality of the bus interface. The data packets formatted according to the second protocol are transferred to the peripheral components via the ports.

A third aspect of the present invention provides a method of sending data packets between a control processor and peripheral components. The method includes retrieving information embedded in a command data packet formatted according to a first protocol at a switch that functions as an alternative bus. The information includes an address of a peripheral component and data for the peripheral component. The method also includes transferring the address of the peripheral component from the switch in a first SMBus Block Write data packet according to the System Management Bus protocol and transferring the data for the peripheral component from the switch in a second SMBus Block Write data packet that follows the first SMBus Block Write data packet according to the System Management Bus protocol. The first protocol differs from the System Management Bus protocol.

### DRAWINGS

FIG. 1 is a block diagram of one embodiment of a system to implement an alternative bus in accordance with the present invention.

FIG. 2 is a block diagram of one embodiment of a system to implement an alternative bus in accordance with the present invention.

FIGS. 3-5 are block diagrams of embodiments of data packets transferred in an alternative bus in accordance with the present invention.

FIG. 6 is a block diagram of one embodiment of a System Management Bus interface in accordance with the present invention.

FIG. 7 is a flow diagram of one embodiment of a System Management Bus state machine in accordance with the present invention.

FIG. 8 is a flow diagram of one embodiment of a method of sending data packets between a control processor and peripheral components in accordance with the present invention.

FIG. 9 is a flow diagram of one embodiment of a method of forming a reformatted data packet at the switch in accordance with the present invention.

FIG. 10 is a flow diagram of one embodiment of a method of receiving a reformatted data packet at a peripheral component in accordance with the present invention.

FIG. 11 is a flow diagram of one embodiment of a method of forming a reformatted data packet at the switch in accordance with the present invention.

In accordance with common practice, the various described features are not drawn to scale but are drawn to emphasize features relevant to the present invention. Reference characters denote like elements throughout figures and text.

### DETAILED DESCRIPTION

In the following detailed description, reference is made to the accompanying drawings that form a part hereof, and in which is shown by way of illustration specific illustrative embodiments in which the invention may be practiced. These embodiments are described in sufficient detail to enable those skilled in the art to practice the invention, and it is to be understood that other embodiments may be utilized and that logical, mechanical and electrical changes may be made without departing from the scope of the present invention. The following detailed description is, therefore, not to be taken in a limiting sense.

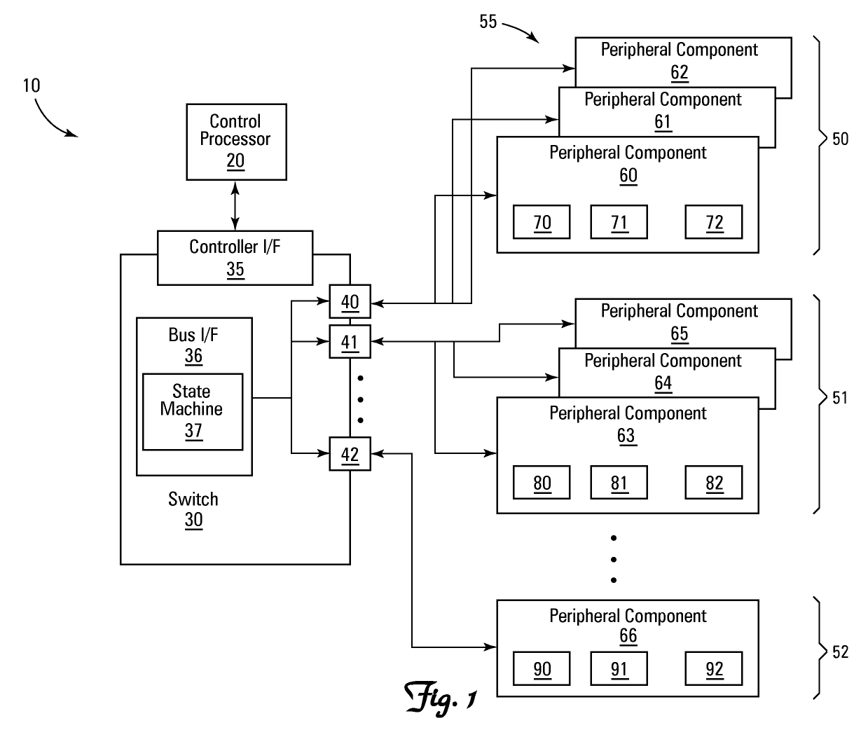

FIG. 1 is a block diagram of one embodiment of a system 10 to implement an alternative bus in accordance with the present invention. In one implementation of this embodiment, the alternative bus of system 10 is implemented when a primary bus fails or slows down due to heavy usage. In this case, a control processor sends data packets to the peripheral components via a switch in the alternative bus of system 10. In another implementation of this embodiment, the control processor sends data packets to the peripheral components via the switch in order to conduct an interrogation of system status and configuration without disrupting the activity on the primary bus. In one implementation of this embodiment, the control processor conducts an interrogation of system status and configuration via the alternative bus when the primary bus fails or slows down due to heavy usage. In another implementation of this embodiment, the control processor conducts all interrogations of system status and configuration via the alternative bus.

The system 10 includes a control processor 20, a switch 30 and a plurality of peripheral components represented generally by the numeral 55. The control processor 20 is communicatively coupled to the switch 30. The control processor 20 sends data packets to the switch 30 when implementing the alternative bus.

The switch 30 includes a controller interface (I/F) 35, a bus interface (I/F) 36 and the plurality of ports generally represented by ports numbered 40, 41, and 42. The controller interface 35 receives data packets that are formatted according to a first protocol from the control processor 20. The bus interface 36 reformats the received data packets from the first protocol to a second protocol. Each data packet formatted according to the second protocol is transferred to one or more of the plurality of peripheral components 55 via one of the communicatively coupled ports 40, 41 or 42. The bus interface 36 includes a bus state machine 37 that controls the functionality of the bus interface 36 during the reformatting of the data packets.

The plurality of peripheral components 55 comprises subsets 50, 51, and 52 of the plurality of peripheral components 55. The subset 50 of the plurality of peripheral components 55 is communicatively coupled to port 40 of the switch 30. The subset 50 includes peripheral components 60-62. A data packet transferred via port 40 is sent to the peripheral components 60-62.

The subset 51 of the plurality of peripheral components 55 is communicatively coupled to port 41 of the switch 30. The subset 51 includes peripheral components 63-65. A data packet transferred via port 41 is sent to the peripheral components 63-65.

Likewise, the subset 52 of the plurality of peripheral components 55 is communicatively coupled to port 44 of the switch 30. The subset 52 includes peripheral component 66. A data packet transferred via port 42 is sent to the peripheral component 66. In one implementation of this embodiment, the subset 52 includes more than one peripheral component.

In one implementation of this embodiment, the switch 30 includes twelve ports. In another implementation of this embodiment, the switch 30 includes twelve ports and each port is communicatively coupled to five peripheral components.

The peripheral components 60-66 each include one or more internal locations. In the illustrated embodiment, the peripheral component 60 includes internal locations 70, 71 and 72, the peripheral component 63 includes internal locations 80, 81 and 82, and the peripheral component 66 includes internal locations 90, 91 and 92. The internal locations in the peripheral components 61, 62, 64, and 65 are not shown in FIG. 1. The control processor 20 accesses configuration and control registers at the internal locations. For example, control processor 20 accesses configuration and control registers at the internal locations 70-72, 80-82, 90-92, in the peripheral components 60, 63, and 66, respectively.

A primary bus (not shown) in the system 10 uses an embedded system primary bus architecture to transfer commands and data, between the control processor 20 and the peripheral components 60-66. When the primary bus is locked-up or producing errors during a transfer of data packets, the control processor 20 uses the switch 30, which functions as an alternate bus for the control processor 20. In order to function as an alternative bus to the primary bus, the bus state machine 37 in the switch 30 reformats data packets received from the control processor 20. Specifically, the bus interface 36 modifies the received data packets that are formatted according to the first protocol so that the data packets sent from the switch 30 are formatted according to a second protocol. In this manner the bus interface 36 and the bus state machine 37 in the switch 30 provide an alternative bus to the embedded system primary bus architecture to transfer commands between the control processor 20 and the peripheral components 60-66. The controller interface 35 receives the address of the peripheral component 60, 61, 62, 63, 64, 65, or 66 and data to be sent to the addressed peripheral component 60, 61, 62, 63 64, 65, or 66. The addressed peripheral component 60, 61, 62, 63 64, 65, or 66 is referred to here as “targeted peripheral component 60, 61, 62, 63 64, 65, or 66.” The peripheral components 60-66 are slave devices for the switch.

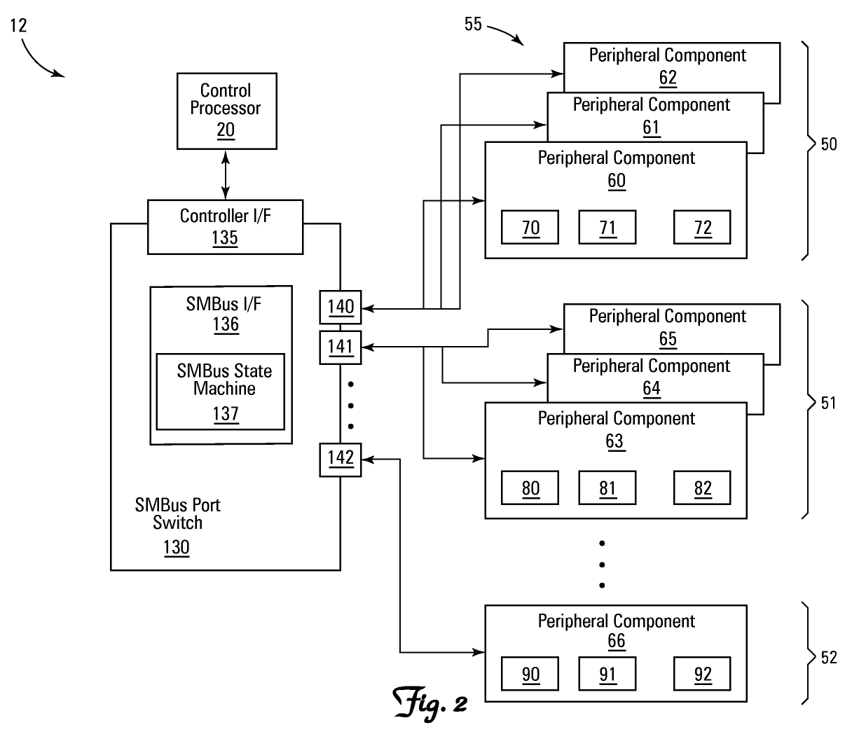

In one implementation of this embodiment, the first protocol data packet received from the controller 20 is a RS232 data packet. In another implementation of this embodiment, the first protocol data packet received from the controller 20 is formatted according to a Spacewire protocol. In yet another implementation of this embodiment, the first protocol data packet received from the controller 20 is formatted according to a Rapid TO protocol. In yet another implementation of this embodiment, the first protocol data packet received from the controller 20 is formatted according to a Spacewire protocol and the second protocol data packet sent from the switch 30 is formatted according to the System Management Bus protocol. A system to implement the latter embodiment is shown in FIG. 2.

FIG. 2 is a block diagram of one embodiment of a system 12 to implement an alternative bus in accordance with the present invention. The alternative bus of system 12 is implemented when a failure of a primary bus is detected or when interrogation of system status and configuration is implemented without disrupting the activity on the primary bus. System 12 is an embodiment of system 10 in which the switch 30 is replaced by a System Management Bus (SMBus) port switch 130, also referred to here as “SMBus switch 130” and “switch 130.” The SMBus port switch 130 includes a SMBus controller interface (I/F) 135, a SMBus interface (I/F) 136 and a plurality of ports 140-144. Specifically, within the SMBus port switch 130, the bus interface 36 is replaced by a System Management Bus interface 136 and the bus state machine 37 is replaced by a System Management Bus state machine 137 that controls the functionality of the System Management Bus interface 136. Thus, system 12 includes the control processor 20, the SMBus port switch 130 and the plurality of peripheral components 55 communicatively coupled to one of the ports 140, 141, or 142 of the SMBus port switch 130. The control processor 20 is communicatively coupled to the SMBus port switch 130. The control processor 20 sends data packets to the SMBus port switch 130.

The plurality of peripheral components 55 comprises subsets 50, 51, and 52 as described above with reference to FIG. 1. The subset 50 is communicatively coupled to port 140 of the switch 130. A data packet transferred via port 140 is sent to the peripheral components 60-62. The subset 51 is communicatively coupled to port 141 of the switch 130. A data packet transferred via port 141 is sent to the peripheral components 63-65. Likewise, the subset 52 is communicatively coupled to port 144 of the switch 130. A data packet transferred via port 142 is sent to the peripheral component 66.

The controller interface 135 receives data packets that are formatted according to a first protocol from the control processor 20. In one implementation of this embodiment, the first protocol is a Spacewire protocol. In another implementation of this embodiment, the first protocol is Rapid IO. In another implementation of this embodiment, the first protocol is RS232 data packets. The bus interface 136 reformats the received data packets from the first protocol to a System Management Bus (SMBus) protocol. A data packet formatted according to the SMBus protocol is transferred to a subset 50, 51, or 52 of the plurality of peripheral components 55 via the respective ports 140, 141 or 142. The SMBus interface 136 includes a SMBus state machine 137 that controls the functionality of the SMBus interface 136 during the reformatting of the data packets.

A primary bus in the system 12 uses an embedded system primary bus architecture to transfer commands and data between the control processor 20 and the plurality of peripheral components 55. When the primary bus is locked-up or producing errors during a transfer of data packets, the control processor 20 uses the switch 130, which functions as an alternate bus for the control processor 20. In order to function as an alternative bus to the primary bus, the bus state machine 137 in the switch 130 reformats data packets. Specifically, the bus interface 136 modifies the received data packets that are formatted according to the first protocol so that the data packets sent from the switch 30 are formatted according to the SMBus protocol. In this manner the bus interface 136 and the bus state machine 137 in the SMBus port switch 130 provide an alternative bus to the embedded system primary bus architecture to transfer commands between the control processor 20 and the peripheral components 60-66.

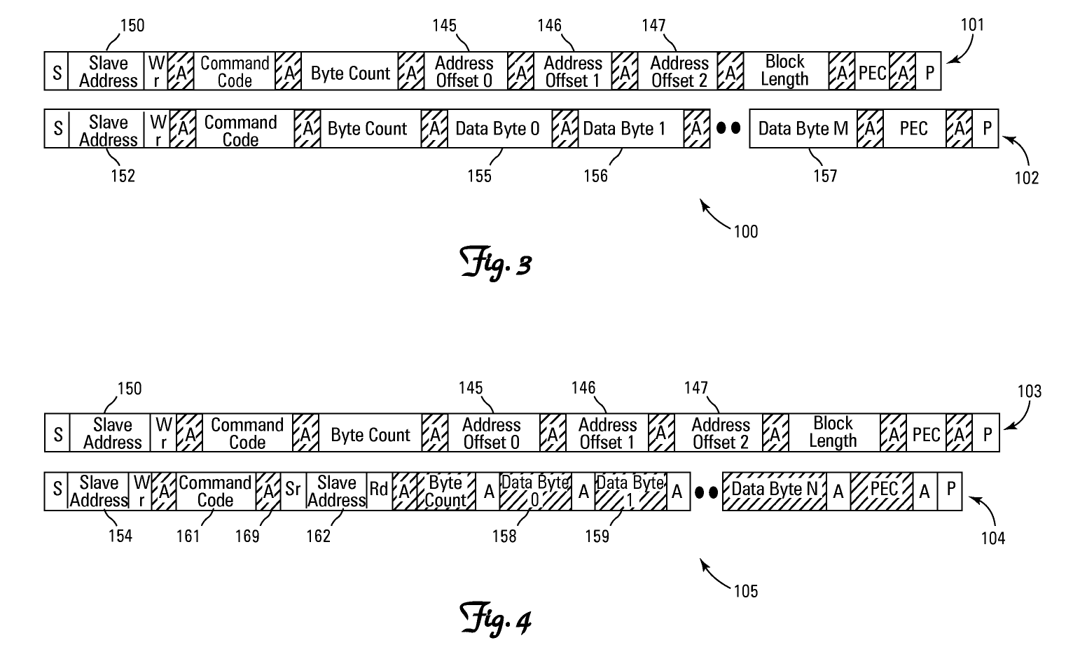

FIGS. 3-5 are block diagrams of embodiments of data packets transferred in an alternative bus in accordance with the present invention. The structure of the data packets reformatted by the switch 30 or SMBus port switch 130 according the SMBus protocol is shown in FIGS. 3-5. For the exemplary data packets shown in FIGS. 3-5, the boxes representative of data fields, for example data byte field 158 in FIG. 4, are hatched to indicate the data is sent from the targeted peripheral component to the switch. Likewise, the un-hatched boxes, for example slave address field 150 of FIG. 3, indicate the data is sent from the switch via a port to the peripheral components communicatively coupled to the port.

FIG. 3 is a block diagram of a reformatted write command data packet 100 formatted according to a System Management Bus protocol in accordance with the present invention. The SMBus port switch 130 transfers information for system writes using data packets 100 structured as a first SMBus Block Write 101 and a second SMBus Block Write 102. A SMBus Block Write is also referred to here as a “SMBus block write data packet” and a SMBus Block Read is also referred to here as a “SMBus block read data packet.”Specifically, the reformatted write command data packet 100 includes a first SMBus Block Write 101 followed by a second SMBus Block Write 102.

The SMBus Block Write 101, also referred to here as “address block write 101,” transfers an address of the targeted peripheral component in the slave address field 150. The SMBus Block Write 101 also transfers the address of the internal location, for example internal location 70 of peripheral component 60, in the address offset field(s) 145, 146, and/or 147. The second SMBus Block Write 102, also referred to here as “data block write 102,” transfers data to the targeted peripheral component in the data byte fields 155, 156 and 157. More or fewer data byte fields can be used as required. The address of the targeted peripheral component is in the slave address field 152 of the SMBus Block Write 102 and is the same as the slave address field 150 in the SMBus Block Write 101.

In one implementation of this embodiment, a first portion of the address block, such as the upper four binary bits in the slave address fields 150 and 152, are decoded by the SMBus port switch 130 to determine which port is being addressed. In this case, the number of peripheral ports connected to the switch is limited to sixteen. A second portion of the address block in the data packet, such as the lower three binary bits in the slave address fields 150 and 152, are decoded by the peripheral components to determine which peripheral component on the port is being addressed. In this case, the number of peripheral components connected to the switch is limited to eight.

Each peripheral component that receives the data packet 100 decodes the lower three bits of the slave address field 150 to determine if it is the targeted peripheral component for the data packet 100. If a peripheral component determines it is the targeted peripheral component, it decodes the address offset field 145 of the SMBus Block Write 101 to determine the address of the targeted internal location. After the internal location is known, the data sent from the switch 130 in the data byte fields 155, 156 and 157 of the data block write 102 of the data packet 100 is stored at the internal location.

For example, a data packet 100 is sent via port 140 (FIG. 2) to the subset 50 of the plurality of peripheral components 55. The peripheral components 60, 61 and 62 each decode the lower three bits of the slave address 150 and 152 to determine if the peripheral component 60, 61 or 62 is the targeted peripheral component for the data packet 100. In this exemplary case, the peripheral component 60 is the targeted peripheral component for data packet 100, and the peripheral component 60 decodes the address offset field(s) 145, 146, and/or 147 in the SMBus Block Write 101 of data packet 100 to determine the internal location for the data packet 100. To continue this exemplary case, the peripheral component 60 determines the data packet 100 is addressed to the internal location 70 and the data within the data byte fields 155, 156 and 157 of the data block write 102 of the data packet 100 is stored in the targeted internal location 70. In one implementation of this embodiment, this process is implemented with switch 30 described above with reference to FIG. 1.

FIG. 4 is a block diagram of a reformatted read command data packet 105 in accordance with the present invention. The targeted peripheral component transfers information for system reads to the SMBus port switch 130 in response to receiving a data packet 105. The data packet is structured as a SMBus Block Write 103 followed by a SMBus Block Read 104. The SMBus Block Write 103, also referred to here as “address block write 103,” transfers an address of the targeted peripheral component in the slave address field 150. The SMBus Block Write 103 also transfers the address of the internal location, for example internal location 70 of peripheral component 60, in the address offset field(s) 145, 146, and/or 147. The SMBus Block Read 104, also referred to here as “data block read 104,” transfers data from the targeted peripheral component to the SMBus port switch 130 in the data byte fields 158 and 159. More or fewer data byte fields can be used as required.

After the targeted peripheral component sends an acknowledgement in data field 169 to acknowledge receipt of the command code 161, the SMBus port switch 130 resends the address of a targeted peripheral component in the second slave address field 162. The second slave address field 162 indicates to the targeted peripheral component that SMBus Block Read 104 is a read data packet. The targeted peripheral component then transfers data from the internal location, which was addressed in address offset field(s) 145, 146, and/or 147. The data from the internal location is sent in the data byte fields 158 and 159 from the targeted peripheral component to the SMBus port switch 130. In this manner, information from the internal location is sent to the switch in response to receiving the read command data packet 105.

In an exemplary case, the targeted peripheral component 63 receives the read command data packet 105 from the switch 130 via port 141; the peripheral component 63 determines that the internal location 82 is targeted in the address offset field(s) 145, 146 and/or 147 of the SMBus Block Write 103; the targeted peripheral component 63 responds to the receipt of the second slave address field 162 by sending data from the targeted internal location 82 in the data byte fields 158 and 159 as part of the SMBus Block Read 104 in the command data packet 105 to the switch 130 via port 142. In this manner, the SMBus Block Read 104 completes the transaction with the switch 130. In one implementation of this embodiment, this process is implemented with switch 30 described above with reference to FIG. 1.

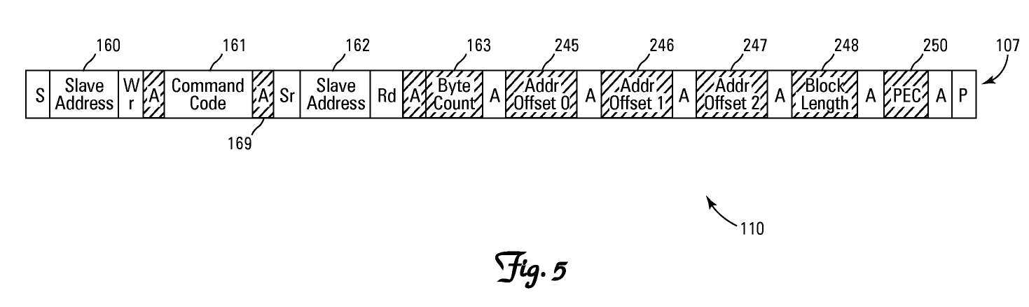

FIG. 5 is a block diagram of a reformatted read command data packet 110 to transfer a command code from the SMBus port switch 130 in a system interrogation in accordance with the present invention. The SMBus port switch 130 interrogates the targeted peripheral component using a reformatted read command data packet 110 structured as a SMBus Address Block Read 107. The SMBus Address Block Read 107 includes an address of a targeted peripheral component in the slave address field 160 and in the slave address field 162 and also includes a selected command code in the command code field 161. After the targeted peripheral component sends the acknowledgement in data field 169 to acknowledge receipt of the command code 161, the SMBus port switch 130 resends the address of a targeted peripheral component in the slave address field 162 to indicate to the targeted peripheral component that SMBus Address Block Read 107 is a read data packet. The data indicative of the address of the internal location used in the peripheral component 60 during the previous SMBus transaction is then sent from the targeted peripheral component to the SMBus port switch 130 in address offset field(s) 245, 246, and/or 247 of the SMBus Address Block Read 107. The targeted peripheral component then transfers data indicative of the number of data bytes accessed in the peripheral component 60 in the previous SMBus transaction. The data indicative of the number of data bytes accessed in the peripheral component 60 in the previous SMBus transaction is sent from the targeted peripheral component to the SMBus switch 130 in the block length field 248 of the SMBus Address Block Read 107. In this manner, the information indicative of how many bytes were accessed and for which internal location of the peripheral component during a previous transaction is transferred via the SMBus switch 130 to the control processor 20 (FIG. 2) and the SMBus Address Block Read 107 completes the transaction with the SMBus switch 130.

The type of data in the response to the switch is dependent upon the command code in the command code field 161. Some exemplary selected command codes are shown in Table 1 with the associated binary bytes assigned to the commands and the associated descriptions of the commands.

TABLE 1
SMBus Command Code Byte

| Command | Assignment | Description | Rd/Wr |
|---|---|---|---|
| Address | 1010 0101 | 24-Bit Address as Payload with | Wr |
| Block Write | | Read/Write Block Length | |
| Data Block | 0011 1100 | Payload of Data Bytes to be | Wr |
| Write | | written to the address contained in | |
| | | a preceding Address Block Write | |
| Data Block | 0110 0110 | Data read from the address | Rd |
| Read | | specified in a preceding Address | |
| | | Block Write. Data to be sent | |
| | | as payload during a Block Read | |
| Address | 1001 1001 | Read Back Payload Address | Rd |
| Block Read | | and Block Length used in | |
| | | last SMBus access | |

In an exemplary case, the peripheral component 66 receives a SMBus Address Block Read 107 from the switch 130. The SMBus Address Block Read 107 includes a selected command code “10011001” (Row 4 of Table 1) in the command code field 161 and the address of the peripheral component 66 in the slave address fields 160 and 162. In this exemplary case, the peripheral component 66 responds to the second slave address field 162 in the SMBus Address Block Read 107 by sending data in the byte count field 163 that indicates the number of data bytes being sent from the peripheral component 66 to the switch 130. The peripheral component 66 then sends data in the address offset field(s) 245, 246, and/or 247 of the SMBus Address Block Read 107 that indicate the internal location 91 of the peripheral component 60 that was used in the previous SMBus transaction. The peripheral component 66 then sends data in the Block Length field 248 to indicate the number of data bytes accessed in the previous SMBus transaction for the peripheral component 66. The peripheral component 66 then sends a PEC data field 250 as a checksum to the switch 130 that is used to protect the integrity of the data sent in the SMBus Address Block Read 107. In one implementation of this embodiment, this process is implemented with switch 30 described above with reference to FIG. 1.

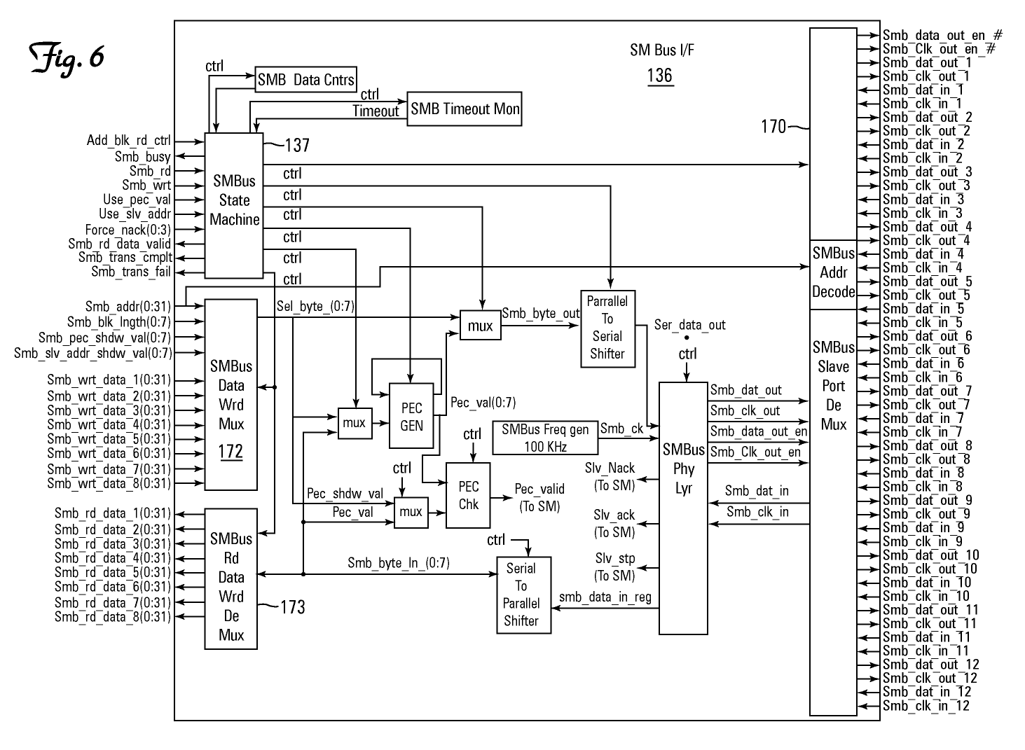

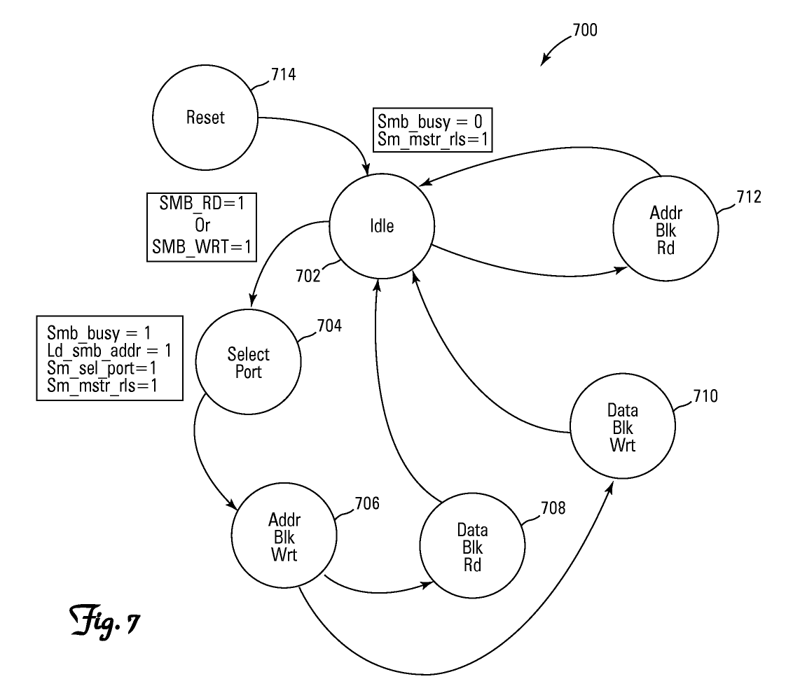

FIG. 6 is a block diagram of one embodiment of a System Management Bus interface 136 in accordance with the present invention. In this exemplary case, the System Management Bus interface (SMBus I/F) 136 is for a SMBus port switch 130 having twelve ports, such as ports 140-142 (FIG. 2). The System Management Bus interface 136 includes the SMBus state machine 137 to control the functionality of the SMBus interface 136 during the reformatting of the data packets to form data packets 100 and 110. The SMBus state machine 137 is communicatively coupled to a SMBus slave port demultiplexer 170, a SMBus data word multiplexer 172 and a SMBus Read data word de-multiplexer 173 to control the SMBus interface 136. The SMBus slave port demultiplexer 170 is communicatively coupled to the ports, such as ports 140-142 (FIG. 2).

An exemplary list of signal names and associated descriptions that are implemented in the SMBus interface 136 is shown in Table 2. The SIGNAL NAME column of Table 2 includes the signals indicated in the embodiment of the SMBus interface 136 for twelve ports shown in FIG. 6. The DESCRIPTION column includes a description of the function of the each signal and the valid numbers of bytes, as necessary, for each signal.

TABLE 2
SMBus Interface Signal List

| SIGNAL NAME | DESCRIPTION |
|---|---|
| SMB_RD_DATA_#(0:31) | Eight 32-bit Read Data Words received from a |
| | SMBus Slave Device and stored in internal |
| | Registers |
| SMB_WRT_DATA_#(0:31) | Eight 32-bit Write Data Words intended for a |
| | SMBus Port |
| SMB_ADDR(0:31) | 32 bit Address intended for SMBus Port |
| SMB_BLK_LNGTH(0:7) | 8 bit Block length indicates number of bytes to |
| | transfer. Valid numbers are 4, 8, 12, 16, 20, 24, |
| | 28, and 32. |
| SMB_PEC_SHDW_VAL(0:7) | invalid 8-bit Packet Error Code (PEC) value used |
| | for testing purposes |
| SMB_SLV_ADDR_SHDW_VAL | invalid 8-bit Slave Address used for testing |
| (0:7) | purposes |
| USE_PEC_VAL | Test Signal indicates SMBus to use invalid PEC |
| | value |
| USE_SLV_ADDR | Test Signal indicates SMBus to use invalid Slave |
| | Address |
| FORCE_NACK(0:3) | Test Signals used to force SMBus NACK events |
| | during reads. |
| SMB_RD | Read control |
| SMB_WRT | Write Control |
| SMB_BUSY | Signal indicates SMBus port is busy |
| SMB_RD_DATA_VALID | Signal indicates SMBus Data is Valid |
| SMB_TRANS_CMPLT | Signal indicates SMBus transaction is complete |
| SMB_TRANS_FAIL | Signal indicates SMBus transaction failed |
| SMB_DAT_OUT_# (# = 1–12) | SMBus Data Out Port # signal |
| SMB_CLK_OUT_# (# = 1–12) | SMBus Clock Out Port # signal |
| SMB_DAT_IN_# (# = 1–12) | SMBus Data Out Port # signal |
| SMB_CLK_IN_# (# = 1–12) | SMBus Clock Out Port # signal |
| SMB_OE_N | SMBus Port Bi-Dir control |

FIG. 7 is a flow diagram 700 of one embodiment of a System Management Bus state machine in accordance with the present invention. The flow is described for an implementation in which the SMBus state machine is the SMBus state machine 137 shown in the SMBus interface 136 of FIG. 6. A reset (block 714) puts the SMBus state machine 137 into the reset mode. The SMBus State Machine then enters IDLE after reset or after completing a transaction.

When the SMBus state machine 137 is in IDLE (block 702), the SMBus state machine 137 outputs signals Sm_busy=0 and Sm_mstr_rls=1 to indicate that the SMBus state machine 137 is in the idle state. When a System Management Bus_RD=1 or SMB_WRT=1 signal is received at the SMBus state machine 137, a port is selected (block 704) and the SMBus state machine 137 outputs signals to indicate it is busy (Smb_busy=1) and outputs signals to control which port is selected (Ld_smb_addr=1, Sm_sel_port=1, and Sm_mstr_rls=1).

An address block write data packet 101 (FIG. 3) is formed (block 706). If a read command was received at the SMBus state machine 137, the flow proceeds to block 708 and a data block read data packet is formed to follow the write data packet formed at block 706. The SMBus state machine 137 returns to the IDLE (block 702) upon completion of the transaction.

If a write command was received at the SMBus state machine 137, the flow proceeds to block 710 and a second data block write data packet 102 (FIG. 3) is formed to follow the first write data packet 101 formed at block 706. The SMBus state machine 137 returns to the IDLE (block 702) upon completion of the data block write data packet.

If an Address Block Read packet 107 (FIG. 5) was received at the SMBus state machine 137, the flow proceeds from block 702 to block 712 and reformatted read command data packet 110 structured as a SMBus Block Read 107 (FIG. 5) is formed. The address block read data packet 107 (FIG. 5) is received by the peripheral component 60, 61, 62, 63, 64, 65, 65, or 66. The SMBus state machine 137 returns to the IDLE (block 702) upon completion of the data block write data packet.

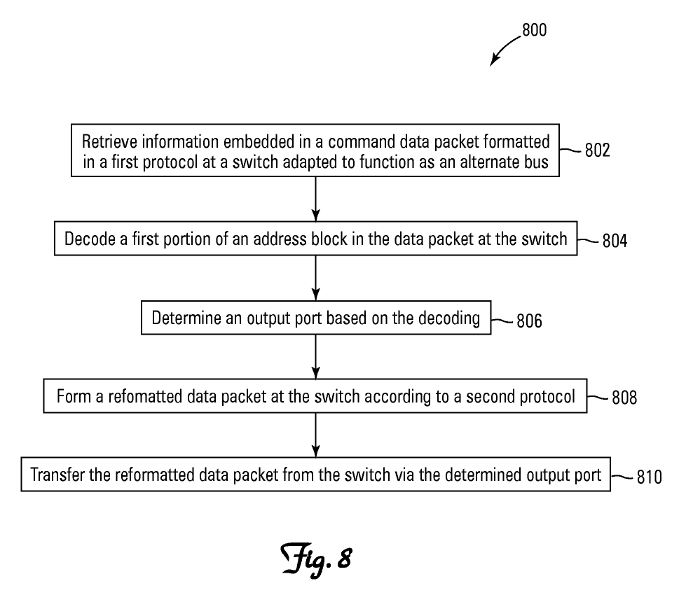

FIG. 8 is a flow diagram of one embodiment of a method 800 of sending data packets between a control processor and peripheral components in accordance with the present invention. In one implementation of this embodiment, the data packets are sent between the control processor 20 and the plurality of peripheral components 55 via the switch 30 of FIG. 1. In another implementation of this embodiment, the data packets are sent between the control processor 20 and the plurality of peripheral components 55 via the SMBus port switch 130 of FIG. 2.

At block 802, information embedded in a command data packet formatted in a first protocol is retrieved at a switch. The switch is adapted to function as an alternate bus. In one implementation of this embodiment, the switch is switch 30 as described above with reference to FIG. 1. In another implementation of this embodiment, the switch is switch 130 as described above with reference to FIG. 2. At block 804, a first portion of an address block in the data packet is decoded at the switch. In one implementation of this embodiment, the address block is slave address field 150 in data packet 100 as described above with reference to FIG. 3. At block 806, an output port is determined based on the decoding.

At block 808, a reformatted data packet is formed at the switch. The reformatted data packet is formatted according to a second protocol and includes the information retrieved during block 802. In one implementation of this embodiment, the reformatted data packet is the data packet 100 as described above with reference to FIG. 3. In another implementation of this embodiment, the reformatted data packet is the data packet 105 as described above with reference to FIG. 4. In yet another implementation of this embodiment, the reformatted data packet is the data packet 110 as described above with reference to FIG. 5. At block 810, the reformatted data packet is transferred from the switch via the output port determined at block 806.

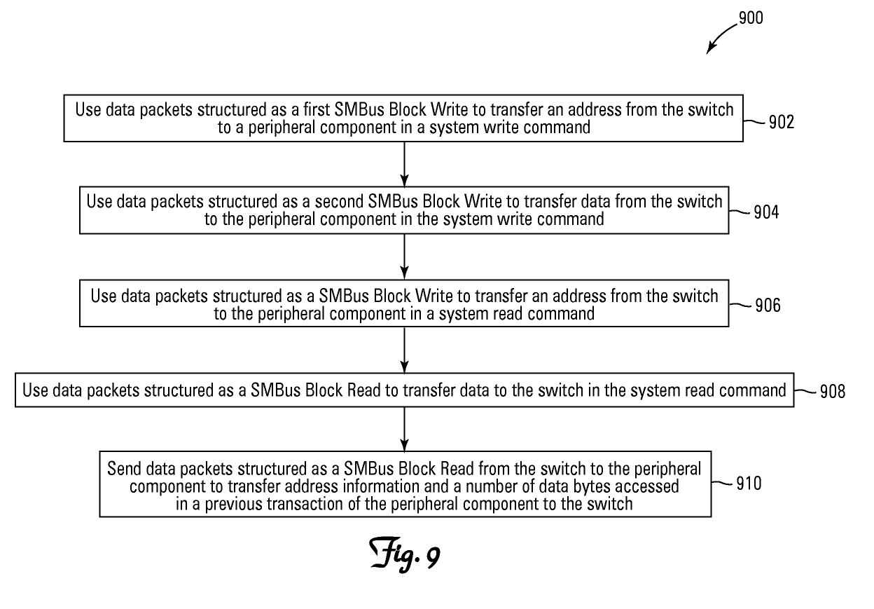

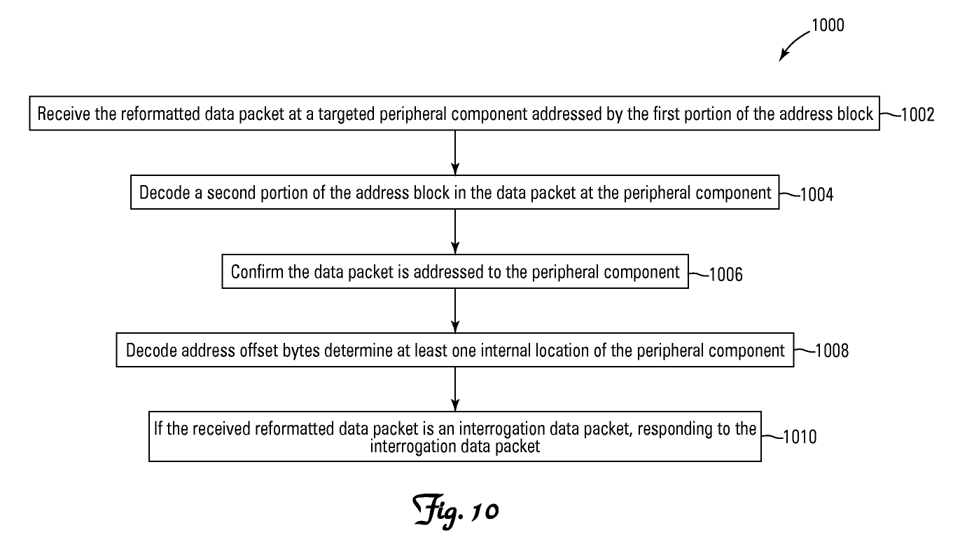

FIG. 9 is a flow diagram of one embodiment of a method 900 of forming a reformatted data packet at the switch in accordance with the present invention. In one implementation of this embodiment, the data packets are reformatted by the switch 30 of FIG. 1 as one of the data packets 100, 105, or 110 of FIG. 3, 4, or 5, respectively. In another implementation of this embodiment, the data packets are reformatted by the SMBus port switch 130 of FIG. 2 as one of the data packets 100, 105, or 110 of FIG. 3, 4, or 5, respectively. In yet another implementation of this embodiment, the data packets received from the control processor 20 at the switch are formatted according to a Spacewire protocol, Rapid IO protocol, or are formatted as a RS232 Data Packet.

At block 902, data packets structured as a first SMBus Block Write are used to transfer an address from the switch to a peripheral component in a system write command. The address is the address of an internal location in a targeted peripheral component. In one implementation of this embodiment, the data packets are reformatted by the switch 130 of FIG. 2 as the first SMBus Block Write 101 of data packet 100 of FIG. 3. At block 904, data packets structured as a second SMBus Block Write are used to transfer data from the switch to the peripheral component in a system write command. The data is sent to the targeted peripheral component's internal location addressed in the data packet of block 902. In one implementation of this embodiment, the data packets are reformatted by the switch 130 of FIG. 2 as the second SMBus Block Write 102 of data packet 100 of FIG. 3.

At block 906, data packets structured as a SMBus Block Write are used to transfer an address from the switch to the peripheral component in a system read command. The transferred address is the address of the internal location in the communicating peripheral component from which the switch is to receive data. In one implementation of this embodiment, the data packets are reformatted by the switch 130 of FIG. 2 as the SMBus Block Write 103 of data packet 105 of FIG. 4.

At block 908, data packets structured as a SMBus Block Read are used to transfer data to the switch in the system read command. In one implementation of this embodiment, the data packets are reformatted by the switch 130 of FIG. 2 as the SMBus Block Read 104 of data packet 105 of FIG. 4. In this case, the data is received by the switch 130, which includes data byte fields 158 and 159, in response to the peripheral component receiving the slave address field 162.

At block 910, data packets structured as a SMBus Address Block Read are initiated by the switch to the peripheral component, in order to transfer address information and a number of data bytes accessed in a previous transaction of the peripheral component to the switch. In one implementation of this embodiment, the data packets are reformatted by the switch 130 of FIG. 2 as the SMBus Block Read 107 of data packet 110 of FIG. 5.

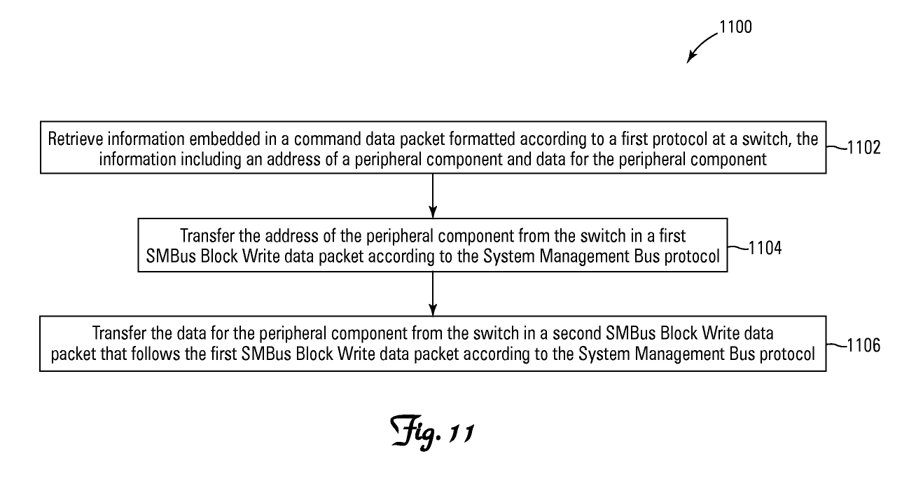

FIG. 10 is a flow diagram of one embodiment of a method 1000 of receiving a reformatted data packet at a peripheral component in accordance with the present invention. In one implementation of this embodiment, the data packets are received by one or more of the peripheral components 60-62 of FIG. 1 as one of the data packets 100 or 110 of FIG. 3 or 5, respectively. In another implementation of this embodiment, the data packets are received by one or more of the peripheral components 60-62 of FIG. 2 as one of the data packets 100 or 110 of FIG. 3 or 5, respectively.

At block 1002, the reformatted data packet is received at a peripheral component addressed by the first portion of the address block. In one implementation of this embodiment, the data packets are reformatted by the switch 130 of FIG. 2 as the second SMBus Block Write 102 of data packet 100 of FIG. 3 and the first portion of the address block is the upper four binary bits in the slave address fields 150 and 152.

At block 1004, a second portion of the address block in the data packet is decoded at the peripheral component. In one implementation of this embodiment, the data packets are reformatted by the switch 130 of FIG. 2 as the second SMBus Block Write 102 of data packet 100 of FIG. 3 and the second portion of the address block is the lower three binary bits in the slave address fields 150 and 152, which are decoded by the subset of peripheral components connected to the port though which the data packet 100 was sent. In this manner, each peripheral component in the subset of peripheral components determines if it is the targeted peripheral component on the port.

At block 1006, the targeted peripheral component confirms the data packet is addressed to the peripheral component. The confirmation is based on the second portion of the address block that was decoded during block 1004.

At block 1008, the peripheral component decodes the address offset bytes to determine at least one internal location of the peripheral component. In one implementation of this embodiment, the number of decoded address offset bytes is in a range from one to thirty one. In another implementation of this embodiment, the data packets are reformatted by the switch 130 of FIG. 2 as the data packet 105 of FIG. 4 and the targeted peripheral component decodes address offset bytes of the address offset field(s) 145, 146, and/or 147.

Block 1010 is implemented if the reformatted data packet is configured as the data packet 110 as described above with reference to FIG. 5. In this case, the peripheral component received an interrogation data packet at block 1002. At block 1010, the peripheral component responds to the interrogation data packet. The response includes the information indicative of the internal location used in the last transaction and the number of data bytes used by the peripheral component in the last transaction. In one implementation of this embodiment, the data packets are reformatted by the switch 130 of FIG. 2 as the SMBus Address Block Read 107 of data packet 110 of FIG. 3. In this implementation, the peripheral component responds to the second slave address field 162 in the SMBus Block Read 107 (also referred to here as interrogation data packet) by sending data in the block length field 248 that indicates the number of data bytes accessed in the previous SMBus transaction for the peripheral component 66. The peripheral component 66 additionally responds to the interrogation data packet by sending data in the address offset field(s) 245, 246, and/or 247 of the SMBus Address Block Read 107 that indicates the internal location 91 of the peripheral component 60 that was used in the previous SMBus transaction.

FIG. 11 is a flow diagram of one embodiment of a method 1100 of forming a reformatted data packet at the switch in accordance with the present invention. In one implementation of this embodiment, the data packets are sent between the control processor 20 and the peripheral components 60-66 via the SMBus port switch 130 of FIG. 2. In another implementation of this embodiment, the data packets are sent between the control processor 20 and a subset of the plurality of peripheral components 55 via the switch 30 of FIG. 1.

At block 1102, information embedded in a command data packet formatted according to a first protocol is retrieved at a switch. The retrieved information includes an address of a peripheral component and data for the peripheral component. In one implementation of this embodiment, the switch is switch 130 as described above with reference to FIG. 2.

At block 1104, the address of the peripheral component is transferred from the switch in a first SMBus Block Write data packet according to the System Management Bus protocol. The first SMBus Block Write data packet is transferred to the peripheral component. In one implementation of this embodiment, the first SMBus Block Write data packet is the first SMBus Block Write 101 as described above with reference to FIG. 3.

At block 1106, the data for the peripheral component is transferred from the switch in a second SMBus Block Write data packet according to the System Management Bus protocol. The second SMBus Block Write data packet follows the first SMBus Block Write data packet and is transferred to the targeted peripheral component. In one implementation of this embodiment, the second SMBus Block Write data packet is the second SMBus Block Write 102 as described above with reference to FIG. 3.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention. Therefore, it is manifestly intended that this invention be limited only by the claims and the equivalents thereof.

What is claimed is:

1. A method of sending data packets between a control processor and a plurality of peripheral components, the method comprising:
retrieving information embedded in a command data packet formatted in a first protocol at a switch adapted to function as an alternate bus;
forming a reformatted data packet at the switch, the reformatted data packet formatted according to a second protocol, the reformatted data packet including the retrieved information; and
transferring the reformatted data packet from the switch.

2. The method of claim 1, wherein the first protocol is at least one of a Spacewire protocol, Rapid IO, RS232 Data Packet, and the second protocol is a System Management Bus protocol, wherein forming a reformatted data packet at the switch comprises:
using data packets structured as a first SMBus Block Write to transfer an address from the switch to a peripheral component in a system write command;
using data packets structured as a second SMBus Block Write to transfer data from the switch to the peripheral component in the system write command;
using data packets structured as a SMBus Block Write to transfer an address from the switch to the peripheral component in a system read command;
using data packets structured as a SMBus Block Read to transfer data to the switch in the system read command; and
sending data packets structured as a SMBus Block Read from the switch to the peripheral component to transfer address information and a number of data bytes accessed in a previous transaction of the peripheral component to the switch.

3. The method of claim 2, further comprising:
decoding a first portion of an address block in the data packet at the switch;
determining an output port based on the decoding; and
transferring the reformatted data packet from the switch via the determined output port.

4. The method of claim 3, further comprising:
receiving the reformatted data packet at a peripheral component addressed by the first portion of the address block; and
decoding a second portion of the address block in the data packet at the peripheral component; and
confirming the data packet is addressed to the peripheral component.

5. The method of claim 4, further comprising:
decoding address offset bytes to determine at least one internal location of the peripheral component.

6. The method of claim 5, wherein the number of decoded address offset bytes is in a range from one to thirty-one.

7. The method of claim 3, wherein the reformatted data packet is an interrogation data packet, the method further comprising:
responding to the interrogation data packet, wherein the response includes information indicative of an internal location used in a last transaction and a number of data bytes used by a peripheral component in the last transaction.

8. The method of claim 1, wherein the second protocol is a System Management Bus protocol, wherein forming a reformatted data packet at the switch comprises:
using data packets structured as a first SMBus Block Write to transfer an address from the switch to a peripheral component in a system write command;
using data packets structured as a second SMBus Block Write to transfer data from the switch to the peripheral component in the system write command;
using data packets structured as a SMBus Block Write to transfer an address from the switch to the peripheral component in a system read command;
using data packets structured as a SMBus Block Read to transfer data to the switch in the system read command; and
sending data packets structured as a SMBus Block Read from the switch to the peripheral component, to transfer address information and a number of data bytes accessed in a previous transaction of the peripheral component to the switch.

9. The method of claim 8, further comprising:
decoding a first portion of an address block in the data packet;
determining an output port based on the decoding; and
transferring the reformatted data packet from the switch via the determined output port.

10. The method of claim 9, further comprising:
receiving the reformatted data packet at a peripheral component addressed by the first portion of the address block;
decoding a second portion of the address block in the data packet at the peripheral component; and
confirming the data packet is addressed to the peripheral component.

11. The method of claim 10, further comprising:
decoding the address offset bytes to determine at least one internal location of the peripheral component being accessed by the data packet.

12. The method of claim 11, wherein the number of decoded address offset bytes is in a range from one to thirty-one.

13. The method of claim 9, wherein the reformatted data packet transferred from the switch is an interrogation data packet, the method further comprising:
responding to the interrogation data packet, wherein the response includes the address of the peripheral component used in the last transaction and the block length is the number of data bytes used by the peripheral component in the last transaction.

14. A switch comprising:
a controller interface adapted to receive data packets formatted according to a first protocol from a control processor;
a bus interface adapted to reformat the received data packets from the first protocol to a second protocol;
a bus state machine adapted to control the functionality of the bus interface; and
ports communicatively coupled to peripheral components, wherein data packets formatted according to the second protocol are transferred to the peripheral components via the ports.

15. The switch of claim 14, wherein the bus interface is a System Management Bus interface, wherein the bus state machine is a System Management Bus state machine, and wherein the first protocol is a Spacewire protocol and the second protocol is a System Management Bus protocol.

16. The switch of claim 14, wherein the bus interface is a System Management Bus interface, wherein the bus state machine is a System Management Bus state machine, and wherein the second protocol is a System Management Bus protocol.

17. The switch of claim 16, wherein the switch is adapted to transfer information for system writes using data packets structured as a first SMBus Block Write and a second SMBus Block Write, wherein the first SMBus Block Write transfers an address of a peripheral component and the second SMBus Block Write transfers data to the peripheral component.

18. The switch of claim 16, wherein the switch is adapted to transfer information for system reads using data packets structured as a SMBus Block Write and a SMBus Block Read, wherein the SMBus Block Write transfers an address of a peripheral component to the switch and the SMBus Block Read transfers data from the peripheral component to the switch.

19. The switch of claim 16, wherein the switch is adapted to interrogate a peripheral component using a data packet structured as a SMBus Block Read, wherein the SMBus Block Read includes a selected command code.

20. A method of sending data packets between a control processor and peripheral components, the method comprising:
retrieving information embedded in a command data packet formatted according to a first protocol at a switch adapted to function as an alternative bus, the information including an address of a peripheral component and data for the peripheral component;
transferring the address of the peripheral component from the switch in a first SMBus Block Write data packet according to the System Management Bus protocol; and
transferring the data for the peripheral component from the switch in a second SMBus Block Write data packet that follows the first SMBus Block Write data packet according to the System Management Bus protocol, wherein the first protocol differs from the System Management Bus protocol.
